(19) United States
(12) Patent Application Publication
(10) Pub. No.: US 2025/0298176 A1
(43) Pub. Date: Sep. 25, 2025

(54) OPTICAL LAMINATE FOR STEREOSCOPIC IMAGE DISPLAY APPARATUS AND STEREOSCOPIC IMAGE DISPLAY APPARATUS

(71) Applicant: SAMSUNG SDI CO., LTD., Yongin-si (KR)

(72) Inventors: Jun Mo KOO, Suwon-si (KR); Dae Hee KWAK, Suwon-si (KR); Hye Yeon JWA, Suwon-si (KR); Seung Jun LEE, Suwon-si (KR); Kwang Ho SHIN, Suwon-si (KR)

(21) Appl. No.: 19/087,238

(22) Filed: Mar. 21, 2025

(30) Foreign Application Priority Data
Mar. 25, 2024 (KR) 10-2024-0040140

(51) Int. Cl. G02B 5/30; G02B 1/08; G02B 30/25

(52) U.S. Cl. CPC G02B 5/3016; G02B 1/08; G02B 30/25

(57) ABSTRACT

An optical laminate for stereoscopic image display apparatuses and a stereoscopic image display apparatus including the same are disclosed. The optical laminate includes: a negative dispersion retardation layer; and a first adhesive layer and a reflective polarizer sequentially formed on one surface of the negative dispersion retardation layer. The first adhesive layer has a storage modulus of 1×10⁶ Pa or more at 25° C.

### CROSS-REFERENCE TO RELATED APPLICATION

The present application claims priority to and the benefit of Korean Patent Application No. 10-2024-0040140, filed on Mar. 25, 2024, in the Korean Intellectual Property Office, the entire disclosure of which is incorporated herein by reference.

### BACKGROUND

### 1. Field

The present disclosure relates to an optical laminate for stereoscopic image display apparatuses and a stereoscopic image display apparatus including the same.

### 2. Description of the Related Art

Recently, display apparatuses capable of displaying stereoscopic images, rather than simply displaying images on a flat screen, have been attracting attention.

Conventional stereoscopic image display apparatuses use a pancake lens assembly. However, a stereoscopic image provided by such a display apparatus has limited resolution. Here, resolution refers to contrast ratio, that is, a difference in brightness between light and dark areas on a screen of the display apparatus. The contrast ratio and resolution of the stereoscopic image display apparatus may be adjusted at various locations in the stereoscopic image display apparatus. For example, the pancake lens is located closest to the user's eyes and thus can affect the resolution of the stereoscopic image display apparatus.

The background technique of the present disclosure is disclosed in Korean Patent Laid-open Publication No. 10-2013-0103595 and similar documents.

### SUMMARY DISCLOSURE

An aspect of the present disclosure is directed toward providing an optical laminate for stereoscopic image display apparatuses that is free from defects such as lifting and/or bubbling upon bonding to a pancake lens including a half mirror and a lens base and is reliably bonded to the pancake lens.

Another aspect of the present disclosure is directed toward providing an optical laminate for stereoscopic image display apparatuses that can improve the contrast ratio and resolution as well as eliminating light leakage at an edge of a screen within a viewer's field of view.

In accordance with one aspect of the present disclosure, an optical laminate for stereoscopic image display apparatuses is provided.

The optical laminate for stereoscopic image display apparatuses includes: a negative dispersion retardation layer; and a first adhesive layer and a reflective polarizer sequentially formed on a first surface of the negative dispersion retardation layer, wherein the first adhesive layer has a storage modulus of 1×10⁶ Pa or more at 25° C.

In accordance with one aspect of the present disclosure, a stereoscopic image display apparatus is provided.

The stereoscopic image display apparatus includes the optical laminate for stereoscopic image display apparatuses described above.

Embodiments of the present disclosure provide an optical laminate for stereoscopic image display apparatuses that is free from defects such as lifting and/or bubbling upon bonding to a pancake lens including a half mirror and a lens base and is reliably bonded to the pancake lens.

Embodiments of the present disclosure provide an optical laminate for stereoscopic image display apparatuses that can improve the contrast ratio and resolution as well as eliminating light leakage at an edge of a screen within a viewer's field of view.

### BRIEF DESCRIPTION OF THE DRAWINGS

The above and other aspects, features, and enhancements of certain embodiments of the disclosure will be more apparent from the following description taken in conjunction with the accompanying drawings, in which:

FIG. 1 to FIG. 9 are each a conceptual view of an optical laminate according to one or more embodiments.

FIG. 10 is a conceptual view of a stereoscopic image display apparatus according to one or more embodiments.

FIG. 11 is a conceptual view illustrating an angular relationship between an optical axis of a first polarizing plate and a slow axis of a negative dispersion retardation layer of an optical laminate in the stereoscopic image display apparatus, according to one or more embodiments.

FIG. 12 is a conceptual view illustrating an angular relationship between an optical axis of a first polarizing plate and a slow axis of a negative dispersion retardation layer of an optical laminate in the stereoscopic image display apparatus, according to one or more embodiments.

FIG. 13 is a cross-sectional view of a first polarizing plate according to one or more embodiments.

FIG. 14 is a conceptual view of a stereoscopic image display apparatus according to one or more embodiments.

### DETAILED DESCRIPTION

Hereinafter, embodiments of the present disclosure will be described with reference to the accompanying drawings. It should be understood that the present disclosure may be embodied in various ways and is not limited to the following embodiments. It should be understood that the following embodiments are provided for complete disclosure and thorough understanding of the disclosure by those skilled in the art. In the drawings, the width or thickness of each element may be exaggerated for descriptive convenience and clarity only. Like components will be denoted by like reference numerals throughout the specification.

The terminology used herein is for the purpose of describing example embodiments and is not intended to limit the present disclosure. As used herein, the singular forms, “a”, “an”, and “the” are intended to include the plural forms as well, unless the context clearly indicates otherwise.

Herein, spatially relative terms such as “upper” and “lower” are defined with reference to the accompanying drawings. Thus, it will be understood that the term “upper surface” can be used interchangeably with the term “lower surface”, and when an element such as a layer or film is referred to as being placed “on” another element, it can be directly placed on the other element, or intervening element(s) may be present. On the other hand, when an element is referred to as being placed “directly on” another element, there are no intervening element(s) therebetween.

Herein, the terms “in-plane retardation Re”, “out-of-plane retardation Rth”, and “degree of biaxiality NZ” are represented by Equations A, B and C, respectively:

$$Re = ( nx - ny ) \times d , \qquad ( A )$$

$$Rth = ( ( nx + ny ) / 2 - nz ) \times d , \qquad ( B )$$

$$NZ = ( nx - nz ) / ( nx - ny ) , \qquad ( C )$$

where nx, ny and nz are the indices of refraction of a corresponding optical device, as measured in the slow axis direction, the fast axis direction, and the thickness direction thereof at a measurement wavelength, respectively, and d is the thickness of the optical device (unit: nm). Here, “slow axis” refers to an axis in which the index of refraction of the optical device in the in-plane direction attains a maximum level and “fast axis” refers to an axis in which the index of refraction of the optical device in the in-plane direction attains a minimum level.

In Equations A to C, the term “optical device” may be a retardation layer, a protective layer, or a laminate of retardation layers (e.g., a retardation layer stack). In Equations A to C, the “measurement wavelength” may be 450 nm, 550 nm, or 650 nm.

Herein, the term “short-wavelength dispersion” refers to Re(450)/Re(550) and “long-wavelength dispersion” refers to Re(650)/Re(550), wherein Re(450), Re(550), and Re(650) refer to in-plane retardation (Re) of the optical device at wavelengths of about 450 nm, 550 nm, and 650 nm, respectively.

Herein, “cross transmittance (Tc)” is an average of values measured on polarized light passing through polarizers arranged orthogonal to each other at a wavelength of 380 nm to 780 nm.

As used herein to represent a specific numerical range, the expression “X to Y” means “greater than or equal to X and less than or equal to Y (X≤ and ≤Y)”.

In accordance with one aspect of the present disclosure, an optical laminate may be used in a stereoscopic image display apparatus. The optical laminate may be disposed on an optical path of light emitted from a display unit (described in more detail below) to adjust the light to enable a user to perceive an artificial reality.

The stereoscopic image display apparatus is capable of implementing artificial reality or is associated with an apparatus that implements artificial reality. Artificial reality is a form of reality that has been adjusted in some manner before presentation to a user. For example, artificial reality may include virtual reality (VR), augmented reality (AR), mixed reality (MR), hybrid reality, or a combination thereof.

According to one or more embodiments, the stereoscopic image display apparatus may include a pancake lens assembly. The pancake lens assembly is an assembly of multiple optical devices that enables a user to perceive an artificial reality by adjusting an optical path of light emitted from the display unit.

According to one or more embodiments, the optical laminate may be included as at least a part of a pancake lens assembly of the stereoscopic image display apparatus, or may form the pancake lens assembly. That is, the optical laminate may be the pancake lens assembly (i.e., the pancake lens assembly consists of the optical laminate).

The optical laminate is free from defects such as lifting and/or bubbling (e.g., formation of bubbles) upon bonding to a pancake lens of the pancake lens assembly, which includes a half mirror and a lens base. The optical laminate can be reliably bonded to the pancake lens. The optical laminate can improve the contrast ratio and resolution of the stereoscopic image display apparatus while eliminating light leakage at an edge of a screen within a viewer's field of view.

According to one or more embodiments, the optical laminate includes: a negative dispersion retardation layer; and a first adhesive layer and a reflective polarizer sequentially formed on one surface of the negative dispersion retardation layer, wherein the first adhesive layer has a modulus of 1×10⁶ Pa or more.

Herein, the term “modulus” refers to a storage modulus and is a value measured by the following method:

Multiple sheets of the first adhesive layer are stacked to a thickness of 500 μm and cut into a circle having a diameter of 8 mm to prepare a specimen, followed by measurement of the storage modulus of the specimen at 25° C. in a temperature sweep test mode under conditions of a frequency of 1 Hz, a strain of 5%, a normal force of 100 N, and a heating rate of 10° C./min from 0° C. to 150° C. using an advanced rheometric expansion system (ARES) (TA instruments Inc.)

The first adhesive layer serves to bond the reflective polarizer to the negative dispersion retardation layer. According to one or more embodiments, the first adhesive layer may be directly formed on each of the reflective polarizer and the negative dispersion retardation layer.

Although not particularly restricted, the optical laminate may be bonded to a pancake lens including a lens base and a half mirror (described in more detail below). When the negative dispersion retardation layer has a thin thickness, the optical laminate can suffer from defects, such as lifting and/or bubbling, upon bonding to the pancake lens and can be prone to detachment from the pancake lens despite being bonded thereto.

As the first adhesive layer has a modulus of 1×10⁶ Pa or more, the optical laminate can be free from the defects described above, such as lifting and/or bubbling, and can be reliably bonded to the pancake lens. In this way, the optical laminate can improve the contrast ratio and resolution of the stereoscopic image display apparatus while eliminating light leakage at an edge of a screen within a viewer' field of view. As will be described in more detail below, the optical laminate may be attached to the pancake lens through a second adhesive layer. In the present disclosure, the first adhesive layer, rather than the second adhesive layer, is designed to have a modulus of 1×10⁶ Pa or more to ensure that the optical laminate does not suffer from the problems described above.

According to one or more embodiments, the first adhesive layer may have a modulus of 1×10⁶ Pa to 1×10⁸ Pa.

According to one or more embodiments, the negative dispersion retardation layer may have a thickness of 5 μm or less, for example, greater than 0 μm and less than or equal to 5 μm, or 1 μm to 5 μm. Within these ranges, the negative dispersion retardation layer can make it easy to provide a thin pancake lens assembly.

Now, the optical laminate according to the present disclosure will be described in more detail.

### Negative Dispersion Retardation Layer

The negative dispersion retardation layer serves to linearly polarize circularly polarized light incident from the pancake lens.

The negative dispersion retardation layer may have a short-wavelength dispersion of 0.81 to 0.87, for example 0.81, 0.82, 0.83, 0.84, 0.85, 0.86, 0.87. Within this range, the negative dispersion retardation layer can eliminate perception of blue ghost images due to leakage of short-wavelength light.

According to one or more embodiments, the negative dispersion retardation layer may have a long-wavelength dispersion of 1.01 to 1.05. As the negative dispersion retardation layer has a long-wavelength dispersion of 1.01 or more, the negative dispersion retardation layer can eliminate perception of red ghost images due to leakage of long-wavelength light. As the negative dispersion retardation layer has a long-wavelength dispersion of 1.05 or less, the negative dispersion retardation layer can eliminate perception of blue ghost images due to leakage of short-wavelength light.

In one or more embodiments, the negative dispersion retardation layer may have a short-wavelength dispersion of 0.84 to 0.87 and a long-wavelength dispersion of for example 1.01, 1.02, 1.03, 1.04, 1.05, 1.02 to 1.05.

The negative dispersion retardation layer may have an in-plane retardation of 130 nm to 150 nm, for example, 130, 131, 132, 133, 134, 135, 136, 137, 138, 139, 140, 141, 142, 143, 144, 145, 146, 147, 148. 149, 150 nm, 135 nm to 145 nm, at a wavelength of 550 nm. Within these ranges, the negative dispersion retardation layer can easily convert circularly polarized light into linearly polarized light.

The negative dispersion retardation layer may be a non-liquid crystal layer, or the negative dispersion retardation layer may be a liquid crystal layer to make it easy to satisfy the thickness requirement described above. According to one or more embodiments, the liquid crystal layer may include a cured product of a liquid crystal composition including at least one selected from among a nematic liquid crystal, a smectic liquid crystal, a discotic liquid crystal, and a cholesteric liquid crystal. In addition, the negative dispersion retardation layer may further include an alignment film to facilitate alignment of a liquid crystal in the liquid crystal layer. The liquid crystal layer and the alignment film can be manufactured by any suitable method (e.g., known to those skilled in the art).

The negative dispersion retardation layer may have a slow axis and a fast axis in an in-plane direction thereof. The slow axis of the negative dispersion retardation layer may be tilted at an angle of 44° to 46°, for example, 45°, or at an angle of 134° to 136°, for example, 135°, with respect to one side of the negative dispersion retardation layer.

The slow axis of the negative dispersion retardation layer may be tilted at an angle of 44° to 46°, for example, 45°, or at an angle of 134° to 136°, for example, 135°, with respect to a light absorption axis of a linear polarizer of the optical laminate (described in more detail below).

### First Adhesive Layer

The first adhesive layer may have a modulus in the range described above and may be of any type of adhesive layer that can ensure reliable adhesive bonding to the negative dispersion retardation layer, the reflective polarizer, or a positive C layer (described in more detail below), without limitation.

According to one or more embodiments, the first adhesive layer may include a pressure sensitive adhesive (PSA) layer.

The first adhesive layer may be formed of a composition including a (meth)acrylic copolymer and a curing agent.

The (meth)acrylic copolymer may include a (meth)acrylic copolymer of a monomer mixture including an alkyl group-containing (meth)acrylic monomer and a crosslinkable functional group-containing (meth)acrylic monomer.

The alkyl group-containing (meth)acrylic monomer may include a (meth)acrylate containing an unsubstituted linear or branched C₁ to C₂₀ alkyl group at an ester site thereof and may include, for example, at least one selected from among methyl (meth)acrylate, ethyl (meth)acrylate, propyl (meth)acrylate, n-butyl (meth)acrylate, isobutyl (meth)acrylate, pentyl (meth)acrylate, hexyl (meth)acrylate, 2-ethylhexyl (meth)acrylate, heptyl (meth)acrylate, octyl (meth)acrylate, isooctyl (meth)acrylate, nonyl (meth)acrylate, decyl (meth)acrylate, and dodecyl (meth)acrylate.

The crosslinkable functional group-containing (meth)acrylic monomer may include at least one of a hydroxyl group-containing (meth)acrylic monomer or a carboxylic acid group-containing (meth)acrylic monomer. In some embodiments, the crosslinkable functional group-containing (meth)acrylic monomer includes a mixture of a hydroxyl group-containing (meth)acrylic monomer and a carboxylic acid group-containing (meth)acrylic monomer to enhance adhesion of the first adhesive layer through reaction with the curing agent.

The hydroxyl group-containing (meth)acrylic monomer may include a (meth)acrylate containing a C₁ to C₂₀ alkyl group having at least one hydroxyl group at an ester site thereof. For example, the hydroxyl group-containing (meth)acrylic monomer may include at least one selected from among 2-hydroxyethyl (meth)acrylate, 2-hydroxypropyl (meth)acrylate, 2-hydroxybutyl (meth)acrylate, 4-hydroxybutyl (meth)acrylate, 6-hydroxyhexyl (meth)acrylate, and 1-chloro-2-hydroxypropyl (meth)acrylate. These monomers may be present (e.g., used) alone or as a mixture thereof in the monomer mixture.

The carboxylic acid group-containing (meth)acrylic monomer may include a (meth)acrylic acid.

The monomer mixture may include 60 wt % to 99 wt %, for example, from 80, 81, 82, 83, 84, 85, 86, 87, 88, 89, 90, 91, 92, 93, 94, 95, 96, 97, 98, 99 wt %, 80 wt % to 99 wt %, of the alkyl group-containing (meth)acrylic monomer and 1 wt % to 40 wt %, for example, 1, 2, 3, 4, 5, 6, 7, 8, 9, 10, 11, 12, 13, 14, 15, 16, 17, 18, 19, 20 wt %, 1 wt % to 20 wt %, of the crosslinkable functional group-containing (meth)acrylic monomer. Within these ranges, the monomer mixture makes it easy to achieve the requirement related to the modulus of the first adhesive layer at 25° C.

According to one or more embodiments, the monomer mixture may include 60 wt % to 99 wt %, for example, 80, 81, 82, 83, 84, 85, 86, 87, 88, 89, 90, 91, 92, 93, 94, 95, 96, 97, 98, 99 wt %, 80 wt % to 99 wt %, of the alkyl group-containing (meth)acrylic monomer, 0.1 wt % to 20 wt %, for example, 0.1, 1, 2, 3, 4, 5, 6, 7, 8, 9, 10 wt %, 0.1 wt % to 10 wt %, of the hydroxyl group-containing (meth)acrylic monomer, and 0.1 wt % to 20 wt %, for example, 0.1, 1, 2, 3, 4, 5, 6, 7, 8, 9, 10 wt %, 0.1 wt % to 10 wt %, of the carboxylic acid group-containing (meth)acrylic monomer. Within these ranges, the monomer mixture makes it easy to achieve the requirement related to the modulus of the first adhesive layer at 25° C.

The alkyl group-containing (meth)acrylic monomer and the crosslinkable functional group-containing (meth)acrylic monomer may present in a total amount of 90 wt % or more, for example, 95 wt % to 100 wt %, or 100 wt %, in the monomer mixture. Within these ranges, the monomer mixture can make it easy to achieve the desired effects of the present disclosure.

The (meth)acrylic copolymer may be prepared by a suitable method (e.g., known to those skilled in the art).

The curing agent is a thermal curing agent and may include at least one selected from among an isocyanate curing agent, an epoxy curing agent, a metal chelate curing agent, an aziridine curing agent, and a carbodiimide curing agent. In some embodiments, the curing agent is an isocyanate curing agent.

The isocyanate curing agent may include toluene diisocyanate including hexamethylene diisocyanate, 2,4-toluene diisocyanate, 2,6-toluene diisocyanate, and/or the like, xylylene diisocyanate including 4,4′-methylenediphenyl diisocyanate, 1,3-xylylene diisocyanate, 1,4-xylylene diisocyanate, and/or the like, hydrogenated toluene diisocyanate, isophorone diisocyanate, 1,3-bis(isocyanatomethyl)cyclohexane, tetramethylxylene diisocyanate, 1,5-naphthalene diisocyanate, 2,2,4-trimethylhexamethylene diisocyanate, 2,4,4-trimethylhexamethylene diisocyanate, toluene diisocyanate adducts of trimethylolpropane including a trimer adduct of trimethylolpropane/toluene diisocyanate and/or the like, xylylene diisocyanate adducts of trimethylolpropane, and/or adducts of any of the aforementioned isocyanate curing agents, such as triphenylmethane triisocyanate, methylene bis(triisocyanate), and/or the like.

The curing agent may be present in an amount of 0.01 parts by weight to 1 part by weight, for example, 0.02 parts by weight to 0.5 parts by weight, relative to 100 parts by weight of the (meth)acrylic adhesive resin. Within these ranges, the curing agent makes it easy to achieve the modulus requirement of the first adhesive layer described above.

The first adhesive layer may be easily prepared using the composition for the first adhesive layer by a suitable method (e.g., known to those skilled in the art).

According to one or more embodiments, the first adhesive layer may have a greater thickness than the negative dispersion retardation layer. As described above, the negative dispersion retardation layer has a thin thickness. This thickness relationship between the first adhesive layer and the negative dispersion retardation layer can aid in reducing bonding defects as described above with the proviso that the first adhesive layer satisfies the modulus requirement described above. According to one or more embodiments, the first adhesive layer may have a thickness of 20 μm or less, for example, greater than 0 μm and less than or equal to 20 μm, or 5 μm to 15 μm.

### Reflective Polarizer

The reflective polarizer reflects linearly polarized light vibrating in one direction while transmitting linearly polarized light vibrating in a direction perpendicular to the one direction.

In one or more embodiments, the reflective polarizer may have a structure in which two different layers having different indices of refraction are alternately formed one above another. For example, the reflective polarizer may be a film in which two different layers having different indices of refraction are formed in the sequence of higher refractive index layer/lower refractive index layer/higher refractive index layer/lower refractive index layer/ . . .

According to one or more embodiments, the reflective polarizer may be a film including a plurality of crystalline domains (for example, polyethylene naphthalate) aligned in one direction within an amorphous matrix (for example, a polycarbonate alloy). For example, the reflective polarizer may be a film including a plurality of polyethylene naphthalate crystalline domains aligned in substantially the same direction within a polycarbonate alloy amorphous matrix.

The thickness of the reflective polarizer may be appropriately selected within the thickness range commonly used for reflective polarizers in the related art. However, the reflective polarizer in the optical laminate may have a thinner thickness. Nevertheless, bonding defects of the optical laminate can be reduced by the first adhesive layer.

According to one or more embodiments, the reflective polarizer may have a thickness of 30 μm or less, for example, greater than 20 μm and less than or equal to 30 μm, or 23 μm to 25 μm.

According to one or more embodiments, the optical laminate may include a single layer of the reflective polarizer, or may include two or more layers of the reflective polarizer.

The optical laminate may further include a positive C retardation layer formed on at least one surface of the negative dispersion retardation layer.

### Positive C Retardation Layer

The positive C retardation layer may be formed on at least one surface of the negative dispersion retardation layer to enhance improvement in the contrast ratio and resolution of a stereoscopic image display apparatus and elimination of light leakage at an edge of a screen within a viewer's field of view.

The optical laminate may include one or more positive C retardation layers as described above.

According to one or more embodiments, the optical laminate may include the positive C retardation layer in the form of a laminate in which the positive C retardation layer is bonded to the negative dispersion retardation layer. Here, the “laminate” (of the positive C retardation layer and the negative dispersion retardation layer) may have a structure in which the positive C retardation layer is directly formed on the negative dispersion retardation layer without any adhesive layer, or may have a structure in which the positive C retardation layer is bonded to the negative dispersion retardation layer through an adhesive layer or the like.

The laminate of the positive C retardation layer and the negative dispersion retardation layer may satisfy the requirement related to the degree of biaxiality at wavelengths of 450 nm, 550 nm, and 650 nm (described in more detail below), thereby providing a wide field of view (FOV) while widening the range of viewing angles with no light leakage and ghost images. Use (e.g., utilization) of a related art negative dispersion retardation film to provide a wide field of view can cause occurrence of light leakage and ghost images at lateral sides of a screen due to decrease in ellipticity at the lateral sides of the screen. The laminate according to one or more embodiments can solve these problems, thereby widening the range of viewing angles with no light leakage and ghost images.

The laminate of the positive C retardation layer and the negative dispersion retardation layer may have a degree of biaxiality of 0.4 to 0.8 at a wavelength of 450 nm, a degree of biaxiality of 0.3 to 0.7 at a wavelength of 550 nm, and a degree of biaxiality of 0.3 to 0.7 at a wavelength of 650 nm.

As the laminate has a degree of biaxiality of 0.4 to 0.8 at a wavelength of 450 nm, the laminate can eliminate perception of blue ghost images due to leakage of short-wavelength light at an edge of a screen within a viewer's field of view. For example, the laminate may have a degree of biaxiality of 0.5 to 0.8, 0.55 to 0.75, or 0.55 to 0.65 at a wavelength of 450 nm. Within these ranges, the laminate can further enhance the desired effects of the present disclosure.

As the laminate has a degree of biaxiality of 0.3 to 0.7 at a wavelength of 550 nm, the laminate can eliminate perception of green ghost images due to leakage of medium wavelength light at an edge of a screen within a viewer's field of view. For example, the laminate may have a degree of biaxiality of 0.45 to 0.7, 0.45 to 0.65, or 0.5 to 0.65 at a wavelength of 550 nm. Within these ranges, the laminate can further enhance the desired effects of the present disclosure.

As the laminate has a degree of biaxiality of 0.3 to 0.7 at a wavelength of 650 nm, the laminate can eliminate perception of red ghost images due to leakage of long-wavelength light at an edge of a screen within a viewer's field of view. For example, the laminate may have a degree of biaxiality of 0.4 to 0.7, 0.4 to 0.6, 0.45 to 0.7, or 0.5 to 0.65 at a wavelength of 650 nm. Within these ranges, the laminate can further enhance the desired effects of the present disclosure.

In some embodiments, the laminate of the negative dispersion retardation layer and the positive C retardation layer has a degree of biaxiality of 0.55 to 0.65 at a wavelength of 450 nm, a degree of biaxiality of 0.4 to 0.65 at a wavelength of 550 nm, and a degree of biaxiality of 0.4 to 0.65 at a wavelength of 650 nm.

According to one or more embodiments, the laminate of the negative dispersion retardation layer and the positive C retardation layer may satisfy the following relationship: degree of biaxiality at a wavelength of 450 nm >degree of biaxiality at a wavelength of 550 nm >degree of biaxiality at a wavelength of 650 nm. According to one or more embodiments, the requirement related to the degrees of biaxiality of the laminate at wavelengths of 450 nm, 550 nm, and 650 nm may be achieved by adjusting the in-plane retardation and out-of-plane retardation of the laminate. Adjustment of the in-plane retardation and out-of-plane retardation of the laminate may be achieved by adjusting the in-plane retardation and/or out-of-plane retardation of the negative dispersion retardation layer and/or the positive C retardation layer of the laminate.

The laminate has negative dispersion properties and may have an in-plane retardation of 112 nm to 132 nm, for example, 117 nm to 127 nm, at a wavelength of 450 nm, an in-plane retardation of 130 nm to 150 nm, for example, 136 nm to 146 nm, at a wavelength of 550 nm, and an in-plane retardation of 133 nm to 153 nm, for example, 138 nm to 148 nm, at a wavelength of 650 nm. Within these ranges, the laminate can easily satisfy the requirement related to the degrees of biaxiality.

The laminate may have an out-of-plane retardation of −70 nm to −10 nm, for example, −70, −65, −60, −55, −50, −45, −40, −35, −30, −25, −20, −15, −10 nm, −60 nm to −30 nm, at a wavelength of 450 nm, an out-of-plane retardation of −55 nm to 5 nm, for example, −55, −50, −45, −40, −35, −30, −25, −20, −15, −10, −5, 0, 5 nm −45 nm to −10 nm, at a wavelength of 550 nm, and an out-of-plane retardation of −40 nm to 15 nm, for example, −40, −35, −30, −25, −20, −15, −10, −5, 0, 5, 10, 15 nm −25 nm to 5 nm, at a wavelength of 650 nm. Within these ranges, the laminate can easily satisfy the requirements related to the degrees of biaxiality.

According to one or more embodiments, the requirement related to the degrees of biaxiality of the laminate at wavelengths of 450 nm, 550 nm, and 650 nm may be achieved by adjusting the in-plane retardation and/or out-of-plane retardation and/or degree of biaxiality of the negative dispersion retardation layer and/or the positive C layer of the laminate.

The negative dispersion retardation layer may have an in-plane retardation of 115 nm to 125 nm, for example, 115, 116, 117, 118, 119, 120, 121, 122, 123, 124, 125 nm, 119 nm to 123 nm, at a wavelength of 450 nm, an in-plane retardation of 130 nm to 150 nm, for example, 130, 131, 132, 133, 134, 135, 136, 137, 138, 139, 140, 141, 142, 143, 144, 145, 146, 147, 148, 149, 150 nm, 135 nm to 145 nm, for example, 139 nm to 143 nm, at a wavelength of 550 nm, and an in-plane retardation of 140 nm to 150 nm, for example, 140, 141, 142, 143, 144, 145, 146, 147, 148, 149, 150 nm, 142 nm to 146 nm, at a wavelength of 650 nm. Within these ranges, the laminate can easily satisfy the requirements related to the degrees of biaxiality.

The negative dispersion retardation layer may have an out-of-plane retardation of 40 nm to 60 nm, for example, 40, 41, 42, 43, 44, 45, 46, 47, 48, 49, 50, 51, 52, 53, 54, 55, 56, 57, 58, 59, 60 nm, 50 nm to 60 nm, at a wavelength of 450 nm, an out-of-plane retardation of 50 nm to 70 nm, for example, 50, 51, 52, 53, 54, 55, 56, 57, 58, 59, 60, 61, 62, 63, 64, 65, 66, 67, 68, 69.70 nm, 55 nm to 70 nm, at a wavelength of 550 nm, and an out-of-plane retardation of 60 nm to 75 nm, for example, 60, 61, 62, 63, 64, 65, 66, 67, 68, 69, 70, 71, 72, 73, 74, 75 nm, 65 nm to 75 nm, at a wavelength of 650 nm. Within these ranges, the laminate can easily satisfy the requirements related to the degrees of biaxiality.

The negative dispersion retardation layer may have a degree of biaxiality of 0.82 to 1.02, for example, 0.82, 0.83, 0.84, 0.85, 0.86, 0.87, 0.88, 0.89, 0.90, 0.91, 0.92, 0.93, 0.94, 0.95, 0.96, 0.97, 0.98, 0.99, 1.00, 1.01, 1.02, 0.91 to 1.00, at a wavelength of 450 nm, a degree of biaxiality of 0.84 to 1.02, for example, 0.84, 0.85, 0.86, 0.87, 0.88, 0.89, 0.90, 0.91, 0.92, 0.93, 0.94, 0.95, 0.96, 0.97, 0.98, 0.99, 1.00, 1.01, 1.02, 0.88 to 1.00, at a wavelength of 550 nm, and a degree of biaxiality of 0.90 to 1.04, for example, 0.90, 0.91, 0.92, 0.93, 0.94, 0.95, 0.96, 0.97, 0.98, 0.99, 1.00, 1.01, 1.02, 1.03, 1.04, 0.95 to 1.03, at a wavelength of 650 nm. Within these ranges, the laminate can easily satisfy the requirement related to the degrees of biaxiality.

The positive C retardation layer may have an in-plane retardation of −3 nm to 7 nm, for example, −2 nm to 4 nm, at a wavelength of 450 nm, an in-plane retardation of −5 nm to 5 nm, for example, −3 nm to 3 nm, at a wavelength of 550 nm, and an in-plane retardation of −7 nm to 3 nm, for example, −4 nm to 2 nm, at a wavelength of 650 nm. Within these ranges, the laminate can easily satisfy the requirements related to the degrees of biaxiality.

The positive C retardation layer has a negative out-of-plane retardation at wavelengths of 450 nm, 550 nm, and 650 nm, and may have an out-of-plane retardation of −120 nm to −70 nm, for example, −110 nm to −70 nm, at a wavelength of 450 nm, an out-of-plane retardation of −105 nm to −65 nm, for example, −100 nm to −70 nm, at a wavelength of 550 nm, and an out-of-plane retardation of −100 nm to −60 nm, for example, −95 nm to −65 nm or −95 nm to −70 nm, at a wavelength of 650 nm. Within these ranges, the laminate can easily satisfy the requirements related to the degrees of biaxiality.

In one or more embodiments, the positive C retardation layer may have positive dispersion properties. This feature can aid in further enhancing the desired effects of the present disclosure. Herein, the term “positive dispersion” means that the positive C retardation layer satisfies Equation 1:

$$\vert {R}_{th} ( 450 ) \vert > \vert {R}_{th} ( 550 ) \vert > \vert {R}_{th} ( 650 ) \vert , \qquad ( 1 )$$

where Rₜₕ(450), Rₜₕ(550), and Rₜₕ(650) are out-of-plane retardations of the positive C retardation layer, as measured at wavelengths of 450 nm, 550 nm, and 650 nm, respectively.

The positive C retardation layer may be formed of any material that can satisfy the dispersion and retardation requirements of the positive C retardation layer, without limitation. The positive c retardation layer may be a liquid crystal layer or a non-liquid crystal layer. The liquid crystal layer may be the same as described above and the non-liquid crystal layer may be the same as described in more detail below.

The positive c-retardation layer may have a thickness of 10 μm or less, for example, greater than 0 μm and less than or equal to 10 μm.

According to one or more embodiments, the positive C retardation layer may be disposed between the negative dispersion retardation layer and the reflective polarizer and/or on the other surface of the negative dispersion retardation layer, that is, a surface of the negative dispersion retardation layer opposite to (e.g., facing away from) the reflective polarizer.

The optical laminate may further include a pancake lens formed on the other surface of the negative dispersion retardation layer.

### Pancake Lens

The pancake lens serves to transmit only a portion of circularly polarized light incident from a first polarizer of a stereoscopic image display apparatus (described in more detail below) while reflecting another portion of the circularly polarized light.

The pancake lens may include a lens base and a half mirror formed on at least one surface of the lens base.

At least one of the two opposing surfaces of the lens base may be curved to facilitate realization of the functions described above. For example, the lens base may include a spherical concave surface, a spherical convex surface, a planar surface, a rotationally symmetrical aspherical surface, or a free-form surface. The lens base may be formed of glass or plastic and may be manufactured by a suitable method (e.g., known in the art with regard to typical pancake lenses).

The half mirror is a translucent mirror that transmits incident light in a ratio of reflectance to transmittance of 50:50, and may include any suitable half mirror used in a stereoscopic image display apparatus.

The optical laminate may further include a second adhesive layer formed on the other surface of the negative dispersion retardation layer.

### Second Adhesive Layer

The second adhesive layer is disposed opposite the first adhesive layer with respect to the negative dispersion retardation layer. The second adhesive layer serves to adhesively bond the negative dispersion retardation layer, the positive C retardation layer, or the pancake lens to each other.

According to one or more embodiments, the second adhesive layer may have the same modulus as the first adhesive layer, or may have a different modulus than the first adhesive layer. For example, the second adhesive layer may have a modulus of 1×10⁶ Pa or less, for example, 1×10³ Pa to 1×10⁶ Pa.

The second adhesive layer is not limited in type, so long as the second adhesive layer can fulfill the role described above. The second adhesive layer may include a photo-cured product or thermally cured product of a composition including at least one adhesive resin selected from among (meth)acrylic resins, epoxy resins, urethane resins, and silicone resins.

The second adhesive layer may have the same thickness as the first adhesive layer, or may have a different thickness than the first adhesive layer. For example, the second adhesive layer may have a thickness of greater than 0 μm and less than or equal to 20 μm, for example, 5 μm to 20 μm.

The optical laminate may further include a linear polarizing plate disposed on an optical path of light transmitted through the reflective polarizer.

### Linear Polarizing Plate

The linear polarizing plate may be disposed on an optical path of light transmitted through the reflective polarizer to transmit only linearly polarized light from the reflective polarizer and absorb other light, thereby enabling a user to view stereoscopic images with high contrast and high resolution.

The linear polarizing plate includes a light absorbing linear polarizer. A light absorption axis of the polarizer (machine direction (MD) of the polarizer) may be tilted at an angle of 44° to 46°, for example, 45°, or at an angle of 134° to 136°, for example, 135°, with respect to a slow axis of the negative dispersion retardation layer.

The polarizer reduces or minimizes ghost images by absorbing linearly polarized light vibrating in a different direction than the linearly polarized light from the reflective polarizer. That is, the polarizer reduces or minimizes ghost images by absorbing linearly polarized light vibrating in a substantially orthogonal direction with respect to the direction in which linearly polarized light from the reflective polarizer vibrates.

The polarizer may have a light absorption axis in an in-plane direction thereof, wherein the light absorption axis may be substantially orthogonal to a light absorption axis of a polarizer of a first polarizing plate (described in more detail below). Herein, the term “substantially orthogonal” may include an angle of 90° or an angle in the range of 90°+5°.

The polarizer may have a degree of polarization of 99% or more, for example, 99.99% to 100%, and a single light transmittance (Ts) of 42% or more, for example, 42% to 45%. Within these ranges of degree of polarization and single light transmittance, the polarizer can be effective at improving the contrast ratio and resolution of a stereoscopic image display apparatus. Here, the term “single light transmittance” refers to single light transmittance (Ts) measured in the visible spectrum, for example, at a wavelength of 400 nm to 700 nm, and may be measured by a suitable method (e.g., known to those skilled in the art). Here, the “degree of polarization” may be measured by a suitable method (e.g., known to those skilled in the art). In some embodiments, the polarizer may have a degree of polarization of 99% to 99.9999% and a light transmittance of 42% to 50%.

The polarizer may include a polyvinyl alcohol-based polarizer manufactured by uniaxial stretching of a polyvinyl alcohol film. In one or more embodiments, the polarizer may be manufactured by treating the polyvinyl alcohol film through a series of processes including dyeing, stretching, crosslinking, and color correction. The requirements related to the degree of polarization and light transmittance of the polarizer may be achieved by appropriately adjusting conditions under which the dyeing, stretching, crosslinking, and color correction processes are performed.

The polarizer may have a thickness of 5 μm to 40 μm. Within this range, the polarizer can be used in the polarizing plate.

The polarizing plate may further include a protective layer formed on at least one surface of the polarizer.

The protective layer may include at least one of an optically clear protective film or an optically clear protective coating layer. The protective film may include a film formed of at least one selected from among cellulose ester resins including triacetylcellulose (TAC) and the like, cyclic polyolefin resins including an amorphous cyclic olefin polymer (COP), polycarbonate resins, polyester resins including polyethylene terephthalate (PET) and the like, polyethersulfone resins, polysulfone resins, polyamide resins, polyimide resins, non-cyclic polyolefin resins, poly(meth)acrylate resins including polymethyl methacrylate and the like, polyvinyl alcohol resins, polyvinyl chloride resins, and polyvinylidene chloride resins, without being limited thereto.

The protective coating layer may be formed of an actinic radiation-curable resin composition including an actinic radiation-curable compound and a polymerization initiator. The actinic radiation-curable compound may include at least one selected from among cationic polymerizable curable compounds, radical polymerizable curable compounds, urethane resins, and silicone resins.

The protective layer may be a zero retardation film or may have a predetermined range of in-plane retardation. For example, the protective layer may have an in-plane retardation of less than 5,000 nm, greater than or equal to 5,000 nm, 120 nm to 160 nm, or 5 nm to 0 nm, at a wavelength of 550 nm. Within these ranges, the protective layer can protect the polarizing plate without altering the desired effects of the laminate of the retardation films.

The protective layer may have a thickness of 10 μm or less, 5 μm to 300 μm, 5 μm or less, or 5 μm to 200 μm. Within these ranges, the protective layer can be used in the polarizing plate.

The protective layer may further include a functional coating layer.

The functional coating layer may be formed on one or both surfaces of the protective layer to provide additional functions to the protective layer or the polarizing plate. The functional coating layer may include at least one selected from among a hard coating layer, an anti-fingerprint layer, an antireflection layer, an antiglare layer, a low reflectivity layer, and an ultra-low reflectivity layer, without being limited thereto.

In one or more embodiments, the functional coating layer may include a low reflectivity layer, an antireflection layer, and/or an antiglare layer. The low reflectivity layer, the antireflection layer, and/or the antiglare layer can aid in reducing or minimizing ghost images by reflecting unwanted light coming from the outside or by absorbing light reflected at an interface. The polarizing plate may include at least one of the low reflectivity layer, the antireflection layer, or the antiglare layer.

For example, each of the low reflectivity layer and the antireflection layer may have a minimum reflectance of 3% or less, for example, 0% to 2%. Within these ranges, the low reflectivity layer and the antireflection layer can aid in reducing or minimizing ghost images.

For example, the antiglare layer may have an external haze of 0% to 50% and an internal haze of 0% to 10%. Within these ranges, the antiglare layer can aid in reducing or minimizing ghost images. Herein, “internal haze” is a value measured in the same manner as in measurement of overall haze of the polarizing plate after spraying alcohol (for example, ethanol) on a glass plate having an overall haze of less than 1%, followed by attaching the glass plate to the antiglare layer to flatten surface irregularities of the antiglare layer. Herein, “overall haze” of the antiglare layer is a value measured using a typical haze meter (for example, a haze meter NHD-2000).

Herein, “external haze” of the antiglare layer may be the difference between the overall haze of the antiglare layer and the internal haze of the antiglare layer. Herein, “haze” is measured in the visible spectrum, for example, at a wavelength of 380 nm to 780 nm, and refers to an average value, unless otherwise stated.

The low reflectivity layer, the antireflection layer, and the antiglare layer may be easily manufactured by a suitable method (e.g., known to those skilled in the art).

The optical laminate may further include a lens disposed on at least one surface of the negative dispersion retardation layer.

According to one or more embodiments, the optical laminate may further include a first lens disposed between the negative dispersion retardation layer and the pancake lens.

According to one or more embodiments, the optical laminate may further include a second lens disposed on an optical path of light transmitted through the linear polarizing plate.

### First Lens and Second Lens

Each of the first lens and the second lens may be disposed on an optical path to produce a clear image.

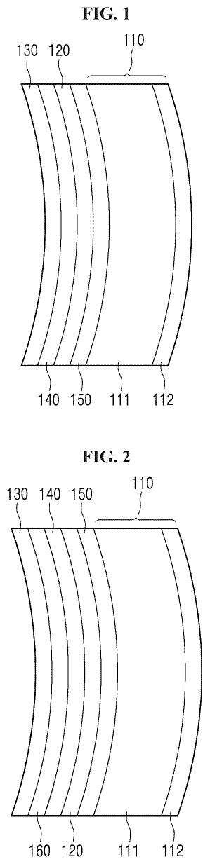

FIG. 1 to FIG. 9 are conceptual views of optical laminates according to various embodiments.

Referring to FIG. 1, an optical laminate may include: a pancake lens 110 including a lens base 111 and a half mirror 112; and a second adhesive layer 150, a negative dispersion retardation layer 120, a first adhesive layer 140, and a reflective polarizer 130 sequentially formed on the pancake lens 110.

Referring to FIG. 2, an optical laminate may include: a pancake lens 110 including a lens base 111 and a half mirror 112; and a second adhesive layer 150, a negative dispersion retardation layer 120, a first adhesive layer 140, a positive C retardation layer 160, and a reflective polarizer 130 sequentially formed on the pancake lens 110.

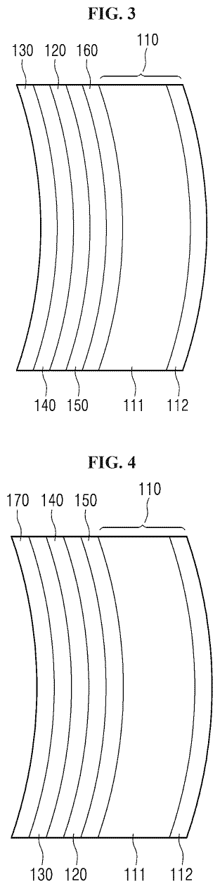

Referring to FIG. 3, an optical laminate may include: a pancake lens 110 including a lens base 111 and a half mirror 112; and a positive C retardation layer 160, a second adhesive layer 150, a negative dispersion retardation layer 120, a first adhesive layer 140, and a reflective polarizer 130 sequentially formed on the pancake lens 110.

Referring to FIG. 4, an optical laminate may include: a pancake lens 110 including a lens base 111 and a half mirror 112; and a second adhesive layer 150, a negative dispersion retardation layer 120, a first adhesive layer 140, a reflective polarizer 130, and a linear polarizing plate 170 sequentially formed on the pancake lens 110.

Referring to FIG. 5, an optical laminate may include: a pancake lens 110 including a lens base 111 and a half mirror 112; and a second adhesive layer 150, a negative dispersion retardation layer 120, a positive C retardation layer 160, a first adhesive layer 140, and a reflective polarizer 130 sequentially formed on the pancake lens 110.

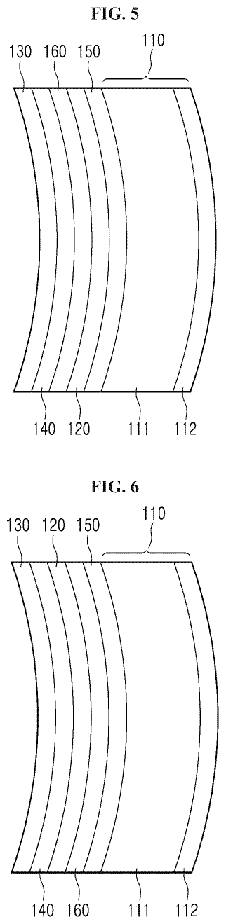

Referring to FIG. 6, an optical laminate may include: a pancake lens 110 including a lens base 111 and a half mirror 112; and a second adhesive layer 150, a positive C retardation layer 160, a negative dispersion retardation layer 120, a first adhesive layer 140, and a reflective polarizer 130 sequentially formed on the pancake lens 110.

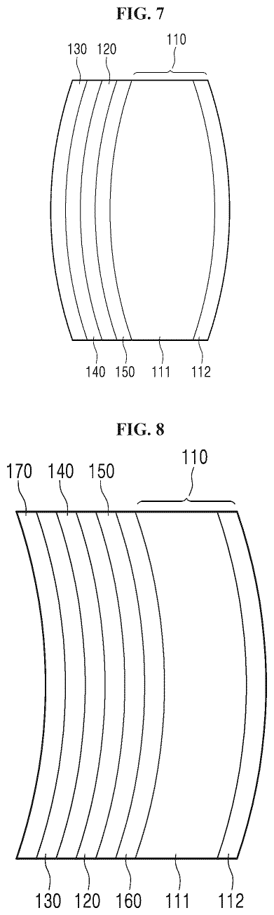

Referring to FIG. 7, an optical laminate may include a pancake lens 110 including a lens base 111 and a half mirror 112; and a second adhesive layer 150, a negative dispersion retardation layer 120, a first adhesive layer 140, and a reflective polarizer 130 sequentially formed on the pancake lens 110.

Referring to FIG. 8, an optical laminate may include: a pancake lens 110 including a lens base 111 and a half mirror 112; and a positive C retardation layer 160, a second adhesive layer 150, a negative dispersion retardation layer 120, a first adhesive layer 140, a reflective polarizer 130, and a linear polarizing plate 170 sequentially formed on the pancake lens 110.

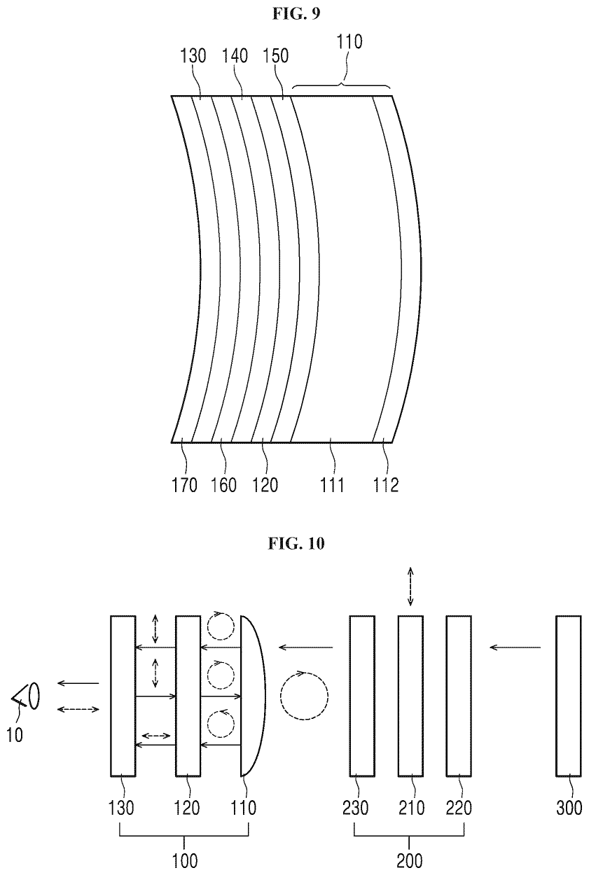

Referring to FIG. 9, an optical laminate may include: a pancake lens 110 including a lens base 111 and a half mirror 112; and a second adhesive layer 150, a negative dispersion retardation layer 120, a first adhesive layer 140, a positive C retardation layer 160, a reflective polarizer 130, and a linear polarizing plate 170 sequentially formed on the pancake lens 110.

### [Stereoscopic Image Display Apparatus]

Another aspect of the present disclosure relates to a stereoscopic image display apparatus.

The stereoscopic image display apparatus includes the optical laminate described above.

According to one or more embodiments, the stereoscopic image display apparatus includes a display unit, a first polarizing plate, and a pancake lens assembly. The pancake lens assembly includes the optical laminate described above.

The first polarizing plate and the pancake lens assembly are disposed on an optical path of light emitted from the display unit. The first polarizing plate is disposed between the display unit and the pancake lens assembly.

With the pancake lens assembly, the stereoscopic image display apparatus can have improved contrast ratio and resolution while eliminating light leakage at an edge of a screen within a viewer's field of view.

A stereoscopic image display apparatus according to one or more embodiments will be described in more detail below.

### Display Unit

The display unit may include a suitable display unit that includes a light emitting device. The light emitting device may include at least one of an organic light emitting device, an inorganic light emitting device, or an organic/inorganic hybrid light emitting device.

### First Polarizing Plate

The first polarizing plate may include a linear polarizer and a retardation layer formed on at least one surface of the linear polarizer.

According to one or more embodiments, the first polarizing plate may include a linear polarizer, a first retardation layer formed on one surface of the linear polarizer, and a second retardation layer formed on the other surface of the linear polarizer.

Each of the first retardation layer and the second retardation layer has negative dispersion properties and may have a short-wavelength dispersion of 0.84 to 0.88 and a long-wavelength dispersion of 1.01 to 1.04. Within these ranges, the stereoscopic image display apparatus can produce substantially the same level of light output for each wavelength to allow a user to perceive the same level of light output for each wavelength, can reduce or eliminate light leakage at an edge of a screen within a viewer's field of view, and can enhance resolution. Here, “resolution” refers to contrast ratio, that is, a difference in brightness between light and dark areas on a screen of the stereoscopic image display apparatus. Higher resolution screens produce fewer ghost images.

In one or more embodiments, the first retardation layer may have a short-wavelength dispersion substantially equal to that of the second retardation layer. In addition, the first retardation layer may have a long-wavelength dispersion substantially equal to that of the second retardation layer. This feature can help to provide uniform images by preventing failure due to different degrees of circular polarization for different wavelengths, which can otherwise lead to users perceiving different levels of light output for different wavelengths. Herein, “substantially equal” includes an error range of −0.001 to +0.001, in addition to being exactly equal.

In one or more embodiments, each of the first retardation layer and the second retardation layer may have a short-wavelength dispersion of 0.85 to 0.87 and a long-wavelength dispersion of 1.02 to 1.03.

In one or more embodiments, a slow axis of the first retardation layer may be substantially orthogonal to a slow axis of the second retardation layer. Herein, “substantially orthogonal” means an angle in the range of 90°+5°, for example, an angle of 90°. This structure can aid in ensuring that the degree of circular polarization that light emitted from the display unit undergoes while passing through the first retardation layer is substantially the same as the degree of circular polarization that the light having passed through the first retardation layer undergoes while sequentially passing through the polarizer and the second retardation layer, thereby reducing light loss and ensuring substantially the same level of light output for each wavelength.

The slow axis of the second retardation layer is substantially orthogonal to the slow axis of the negative dispersion retardation layer of the pancake lens assembly. Herein, “substantially orthogonal” refers to an angle in the range of 90°+5°, for example, an angle of 90°. This structure can aid in eliminating ghost images and blocking light leakage due to internal scattering.

According to one or more embodiments, the polarizer of the first polarizing plate may have a cross transmittance of 0.1% or less, for example, 0% to 0.1% or 0.01 to 0.1%. Within these ranges, the polarizer of the first polarizing plate can aid in reducing or minimizing ghost images by providing an enhanced antireflection effect to the display apparatus satisfying the angular relationship between the slow axes described above. In addition, the aforementioned short-wavelength dispersion and long-wavelength dispersion characteristics of the retardation layers make it easy to enhance the aforementioned effects when a polarizer having a cross transmittance in the above ranges is used in the first polarizing plate.

In one or more embodiments, the first retardation layer may have an in-plane retardation of 115 nm to 125 nm, for example, 119 nm to 123 nm, at a wavelength of 450 nm. The first retardation layer may have an in-plane retardation of 135 nm to 145 nm, for example, 139 nm to 143 nm, at a wavelength of 550 nm. The first retardation layer may have an in-plane retardation of 140 nm to 150 nm, for example, 142 nm to 146 nm, at a wavelength of 650 nm. Within these ranges, the first retardation layer can easily satisfy the short-wavelength dispersion and long-wavelength dispersion requirements described above.

In one or more embodiments, the second retardation layer may have an in-plane retardation of 115 nm to 125 nm, for example, 119 nm to 123 nm, at a wavelength of 450 nm. The second retardation layer may have an in-plane retardation of 135 nm to 145 nm, for example, 139 nm to 143 nm, at a wavelength of 550 nm. The second retardation layer may have an in-plane retardation of 140 nm to 150 nm, for example, 142 nm to 146 nm, at a wavelength of 650 nm. Within these ranges, the second retardation layer can easily satisfy the short-wavelength dispersion and long-wavelength dispersion requirements described above.

According to one or more embodiments, the slow axis of the first retardation layer may be tilted at an angle of substantially 45° with respect to a reference. The slow axis of the second retardation layer may be tilted at an angle of substantially 135° with respect to the reference. At these angles, each of the first retardation layer and the second retardation layer can increase the degree of circular polarization of light emitted from the display unit.

According to another embodiment, the slow axis of the first retardation layer may be tilted at an angle of substantially 135° with respect to the reference. The slow axis of the second retardation layer may be tilted at an angle of substantially 45° with respect to the reference. Within these ranges, each of the first retardation layer and the second retardation layer can increase the degree of circular polarization of light emitted from the display unit.

Herein, the “reference” refers to a light absorption axis of the linear polarizer of the first polarizing plate. The light absorption axis of the polarizer corresponds to a machine direction of the polarizer. Assuming that the display unit has a longer side in a longitudinal direction and a shorter side in a transverse direction, the light absorption axis of the polarizer may be oriented in substantially the same direction as the longitudinal direction of the display unit.

In one or more embodiments, the first retardation layer may have an out-of-plane retardation of 50 nm to 80 nm, for example, 55 nm to 75 nm, at a wavelength of 550 nm. Within these ranges, the first retardation layer can easily satisfy the in-plane retardation requirement described above while aiding in reduction in thickness of the first polarizing plate. In one or more embodiments, the first retardation layer may have a degree of biaxiality of 0.7 to 1.1, for example, 0.8 to 1.0, at a wavelength of 550 nm. Within these ranges, the first retardation layer can easily satisfy the in-plane retardation requirement described above while aiding in reduction in thickness of the first polarizing plate.

In one or more embodiments, the second retardation layer may have an out-of-plane retardation of 50 nm to 80 nm, for example, 55 nm to 75 nm, at a wavelength of 550 nm. Within these ranges, the second retardation layer can easily satisfy the in-plane retardation requirement described above while aiding in reduction in thickness of the first polarizing plate. In one or more embodiments, the second retardation layer may have a degree of biaxiality of 0.7 to 1.1, for example, 0.8 to 1.0, at a wavelength of 550 nm. Within these ranges, the second retardation layer can easily satisfy the in-plane retardation requirement described above while aiding in reduction in thickness of the first polarizing plate.

Each of the first retardation layer and the second retardation layer may have a thickness of 1 μm to 40 μm, for example, 1.5 μm to 35 μm. Within these ranges, the first retardation layer and the second retardation layer can be used in the first polarizing plate.

Each of the first retardation layer and the second retardation layer may be formed of any suitable material that can satisfy the dispersion and retardation requirements described above, without limitation.

Each of the first retardation layer and the second retardation layer may be a liquid crystal layer or a non-liquid crystal layer.

In one or more embodiments, each of the first retardation layer and the second retardation layer may be a liquid crystal layer. For example, the liquid crystal layer may include a cured product of a liquid crystal composition including at least one selected from among a nematic liquid crystal, a smectic liquid crystal, a discotic liquid crystal, and a cholesteric liquid crystal. Each of the first retardation layer and the second retardation layer may further include an alignment film to facilitate alignment of a liquid crystal in the liquid crystal layer. Here, the liquid crystal layer and the alignment layer can be easily prepared by a suitable method (e.g., known to those skilled in the art).

In embodiments in which each of the first retardation layer and the second retardation layer is a liquid crystal layer, the short-wavelength dispersion and long-wavelength dispersion requirements described above may be achieved by adjusting the thickness of the liquid crystal layer, the type of liquid crystal molecules forming the liquid crystal layer, the content of liquid crystal molecules in the liquid crystal layer, and the like.

In embodiments in which each of the first retardation layer and the second retardation layer is a liquid crystal layer, each of the first retardation layer and the second retardation layer may further include an optical film. The optical film facilitates formation of the liquid crystal layer without affecting retardation of the first retardation layer and the second retardation layer.

In one or more embodiments, the optical film may have an in-plane retardation of 10 nm or less, for example, 0 nm to 5 nm, at a wavelength of 550 nm. Within these ranges, there is no influence of the optical film on retardation of the first retardation layer and the second retardation layer.

In one or more embodiments, the optical film may be a film including (e.g., formed of) an optically clear resin. For example, the resin may include at least one selected from among cellulose resins including triacetylcellulose and the like, polyester resins including polyethylene terephthalate (PET), polybutylene terephthalate, polyethylene naphthalate, polybutylene naphthalate, and the like, cyclic olefin copolymer (COC) resins, cyclic olefin polymer (COP) resins, polycarbonate resins, polyether sulfone resins, polysulfone resins, polyamide resins, polyimide resins, polyolefin resins, polyarylate resins, polyvinyl alcohol resins, polyvinyl chloride resins, polyvinylidene chloride resins, and acrylic resins.

In one or more embodiments, each of the first retardation layer and the second retardation layer may be a non-liquid crystal layer.

For example, the non-liquid crystal layer may be a film obtained by uniaxially stretching an unstretched film of an optically clear resin in the MD or transverse direction (TD) thereof or by biaxially stretching the unstretched film in the MD and TD thereof. Here, the optically clear resin is substantially the same as described above.

In embodiments in which each of the first retardation layer and the second retardation layer is a non-liquid crystal layer, the short-wavelength dispersion and long-wavelength dispersion requirements described above may be achieved by adjusting the thickness of the non-liquid crystal layer, the direction of stretching and/or degree of stretching in preparation of the non-liquid crystal layer, the type of resin used in preparation of the non-liquid crystal layer, and the like. For example, the non-liquid crystal layer may be a coating layer prepared by coating a composition including at least one of a cellulose compound or a polystyrene compound as a main component, followed by drying and/or curing.

In embodiments in which each of the first retardation layer and the second retardation layer is a non-liquid crystal layer, each of the first retardation layer and the second retardation layer may further include an optical film. The optical film facilitates formation of the coating layer without affecting retardation of the first retardation layer and the second retardation layer. Because the optical film is substantially the same as described above, detailed description thereof is omitted.

The polarizer may have a degree of polarization of 99% or more, for example, 99.99% to 100%, and a single light transmittance (Ts) of 42% or more, for example, 42% to 45%. Within these ranges of degree of polarization and single light transmittance, the polarizer can have a significantly low reflectance when formed on a retardation film.

The polarizer may include a polyvinyl alcohol-based polarizer obtained by uniaxial stretching of a polyvinyl alcohol film. In one or more embodiments, the polarizer may be manufactured by treating the polyvinyl alcohol film through a series of processes including dyeing, stretching, crosslinking, and color correction. The requirements related to the degree of polarization and light transmittance of the polarizer may be achieved by appropriately adjusting conditions under which the dyeing, stretching, crosslinking, and color correction processes are performed.

The polarizer may have a thickness of 5 μm to 40 μm. Within these ranges, the polarizer can be used in the polarizing plate.

A resin layer may be further formed on a surface of the polarizer facing the pancake lens assembly.

In one or more embodiments, the resin layer may be directly formed on and bonded to the surface of the polarizer facing the pancake lens assembly. Herein, “directly formed” means that no other adhesive layer, bonding layer, and/or curable coating layer is formed between the polarizer and the resin layer. The resin layer provides enhanced removal of ghost images by covering fine irregularities on the surface of the polarizer. The resin layer may be a cured product of a composition including at least one of a heat-curable resin or a UV-curable resin. Each of the heat-curable resin and the UV-curable resin may be selected from among suitable heat-curable resins or UV-curable resins (e.g., known to those skilled in the art). For example, the resin layer may include a cured product of a composition including a (meth)acrylic resin.

In one or more embodiments, a laminate of the resin layer and an optical film may be formed on the surface of the polarizer facing the pancake lens assembly. The optical film enhances mechanical strength of the first polarizer, and the resin layer provides enhanced removal of ghost images by covering fine irregularities on the surface of the optical film. The resin layer and the optical film may be substantially the same as described above.

In one or more embodiments, the resin layer may include a hard coating layer, without being limited thereto.

In one or more embodiments, the optical film and the resin layer may be sequentially formed on the surface of the polarizer facing the pancake lens assembly.

The first polarizing plate may further include a protective layer, a functional coating layer, and/or a protective layer with a functional coating layer formed thereon, at an outermost side thereof facing the pancake lens assembly.

The protective layer protects the polarizer and enhances the reliability and mechanical strength of the first polarizing plate. The protective layer may be omitted if desired mechanical properties of the first polarizing plate can be secured without the protective layer.

In one or more embodiments, the protective layer may be formed on a surface of the second retardation layer facing the pancake lens assembly.

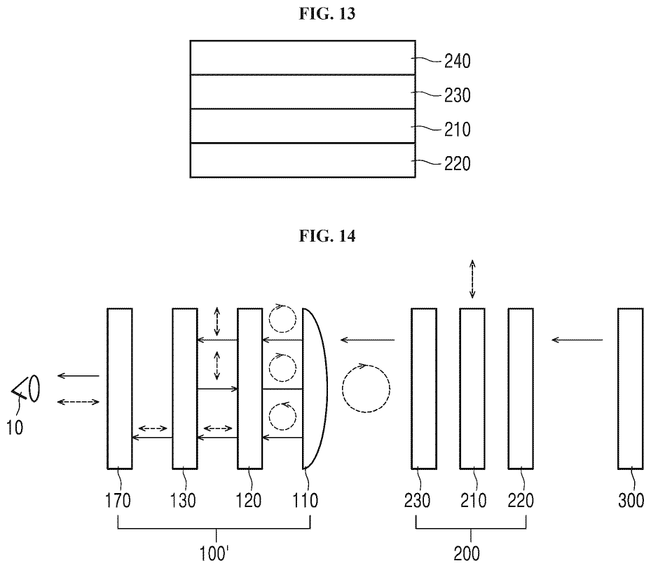

FIG. 13 is a cross-sectional view of a first polarizing plate according to one or more embodiments.

Referring to FIG. 13, the first polarizing plate may include: a first polarizer 210; a first retardation layer 220 bonded to a surface of the first polarizer 210 facing the display unit (not shown); and a second retardation layer 230 and a protective layer 240 sequentially bonded to a surface of the first polarizer 210 facing the pancake lens assembly (not shown), and the protective layer 240 has a functional coating layer formed thereon.

Although not shown in FIG. 13, in one or more embodiments, a bonding layer or an adhesive layer (for example, a pressure sensitive adhesive (PSA) layer) may be disposed to bond the first retardation layer, the second retardation layer, and the protective layer to the first polarizer.

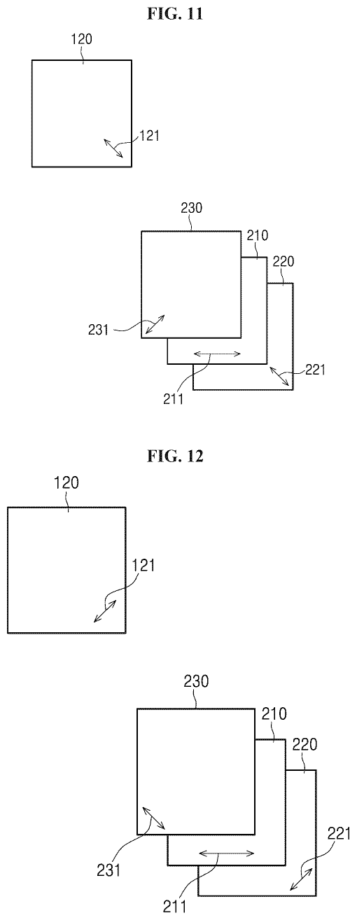

FIG. 11 and FIG. 12 are views illustrating an axial relationship between the first polarizing plate and the retardation film of the pancake lens assembly according to various embodiments.

Referring to FIG. 11, in the first polarizing plate, the light absorption axis 211 of the first polarizer 210 may be tilted at an angle of substantially 45° with respect to the slow axis 221 of the first retardation layer 220 and tilted at an angle of substantially 135° with respect to the slow axis 231 of the second retardation layer 230, and the slow axis 221 of the first retardation layer 220 may be substantially orthogonal to the slow axis 231 of the second retardation layer 230.

Referring to FIG. 12, in the first polarizing plate, the light absorption axis 211 of the first polarizer 210 may be tilted at an angle of substantially 135° with respect to the slow axis 221 of the first retardation layer 220 and tilted at an angle of substantially 45° with respect to the slow axis 231 of the second retardation layer 230, and the slow axis 221 of the first retardation layer 220 may be substantially orthogonal to the slow axis 231 of the second retardation layer 230.

In one or more embodiments, the first polarizing plate may have a light transmittance of 3% or less, for example, 0% to 3%, at a wavelength of 380 nm. Within these ranges, the first polarizing plate can prevent or reduce damage to the light emitting device of the display unit due to UV light coming in from the outside. Any suitable method of realizing light transmittance in the above range can be used (e.g., a typical method known to those skilled in the art). For example, a light absorber capable of absorbing light at a wavelength of 380 nm may be incorporated into one of the components of the first polarizing plate.

### Pancake Lens Assembly

The pancake lens assembly includes the optical laminate described above.

Referring to FIG. 11 and FIG. 12, the slow axis 231 of the second retardation layer 230 may be substantially orthogonal to the slow axis 121 of the negative dispersion retardation layer 120 of the pancake lens assembly.

FIG. 10 is a conceptual view of a stereoscopic image display apparatus according to one or more embodiments.

Referring to FIG. 10, a stereoscopic image display apparatus includes: a display unit 300; a first polarizing plate 200 including a first retardation layer 220, a first polarizer 210, and a second retardation layer 230; and a pancake lens assembly 100 including a pancake lens 110, a negative dispersion retardation layer 120, and a reflective polarizer 130. Light finally emitted through the pancake lens assembly 100 is perceived by a user's eyes 10.

FIG. 14 is a conceptual view of a stereoscopic image display apparatus according to one or more embodiments.

Referring to FIG. 14, a stereoscopic image display apparatus includes: a display unit 300; a first polarizing plate 200 including a first retardation layer 220, a first polarizer 210, and a second retardation layer 230; and a pancake lens assembly 100′ including a pancake lens 110, a negative dispersion retardation layer 120, a reflective polarizer 130, and a linear polarizing plate 170. Light finally emitted through the pancake lens assembly 100′ is perceived by a user's eyes 10.

Next, the present disclosure will be described in more detail with reference to some examples. However, it should be noted that these examples are provided for illustration only and are not to be construed in any way as limiting the present disclosure.

### Example 1

### Preparation of Optical Laminate

A monomer mixture including 96.5 parts by weight of n-butyl acrylate (BA), 1 part by weight of 2-hydroxyethyl acrylate (2-HEA), and 2.5 parts by weight of acrylic acid was prepared in a 1 L reactor provided with a reflux condenser for easy temperature control and a nitrogen gas inlet. The reactor containing the monomer mixture was purged with nitrogen at 65° C. for 1 hour, followed by addition of 0.06 parts by weight of azobisisobutyronitrile (AIBN) as a reaction initiator. Reaction was performed for 8 hours with the temperature of the reactor maintained at 70° C. After completion of the reaction, 130 parts by weight of ethyl acetate was added to prepare a solution of a methacrylic copolymer (weight average molecular weight: about 900,000 g/mol). Thereafter, 0.3 parts by weight of an isocyanate curing agent (Coronalte L) was added thereto and mixed with 100 parts by weight of the prepared methacrylic copolymer, thereby preparing a composition for a first adhesive layer. The prepared composition was deposited to a predetermined thickness on a release film (PET film), followed by drying and aging, thereby preparing a first adhesive layer. The thickness and modulus of the first adhesive layer are shown in Table 1. The modulus of the first adhesive layer was measured by the method described above.

A negative dispersion retardation layer (liquid crystal layer, thickness: 3 μm, short-wavelength dispersion: 0.85, long-wavelength dispersion: 1.02, in-plane retardation at 450 nm: 121.6 nm, in-plane retardation at 550 nm: 141.0 nm, in-plane retardation at 650 nm: 144.4 nm, out-of-plane retardation at 450 nm: 57.2 nm, out-of-plane retardation at 550 nm: 66.4 nm, out-of-plane retardation at 650 nm: 67.9 nm, DNP Co., Ltd.) was prepared.

A reflective polarizer (film with alternating high and low refractive index layers, thickness: 24 μm, IQP-E, 3M Company) and a pancake lens with a half mirror (HARP, 3M Company) were prepared.

The negative dispersion retardation layer was attached to the reflective polarizer through the first adhesive layer and then attached to the pancake lens with the half mirror through a second adhesive layer, thereby obtaining an optical laminate. The second adhesive layer was an acrylic pressure sensitive adhesive layer.

### Preparation of First Polarizing Plate

A first polarizer (single light transmittance: 44%, cross transmittance: 0.2%, thickness: 10 μm) was prepared by dyeing a polyvinyl alcohol film (pre-stretching thickness: 60 μm, Kuraray Co., Ltd., Japan) in an aqueous solution of iodine at 55° C., followed by uniaxially stretching the dyed film to six times an initial length thereof in the MD thereof.

After a triacetylcellulose film was attached to one surface of the first polarizer, a composition including an acrylic resin was coated onto one surface of the triacetylcellulose film, followed by curing, thereby obtaining a laminate in which the first polarizer, the triacetylcellulose film, and a resin layer were sequentially formed. A first retardation layer and a second retardation layer were attached to opposite surfaces of the laminate, thereby preparing a first polarizing plate having a stacked structure of first retardation layer (liquid crystal layer)-first polarizer-triacetylcellulose film-resin layer-second retardation layer (liquid crystal layer). Each of the first retardation layer and the second retardation layer had negative dispersion properties and had a short-wavelength dispersion of 0.86 and a long-wavelength dispersion of 1.02.

### Preparation of Module for Stereoscopic Image Display Apparatus

A module for stereoscopic image display apparatuses was prepared by arranging the first polarizing plate, a display unit having an organic light emitting diode (OLED), and the pancake lens assembly as shown in FIG. 8. Here, the slow axis of the second retardation film of the first polarizing plate was at an angle of 90° to the slow axis of the retardation film of the pancake lens assembly.

In the first polarizing plate, the light absorption axis of the polarizer was at an angle of 45° to the slow axis of the first retardation film, and the slow axis of the first retardation film was at an angle of 90° to the slow axis of the second retardation film.

### Examples 2 to 4

Modules for stereoscopic image display apparatuses were prepared in the same manner as in Example 1 except that the content of each component used in preparation of the first adhesive layer was changed to change the thickness and modulus of the first adhesive layer as shown in Table 1.

### Example 5

### Preparation of Optical Laminate

A first adhesive layer, a negative dispersion retardation layer, and a reflective polarizer were prepared in the same manner as in Example 1.

A positive C retardation layer (liquid crystal layer, out-of-plane retardation at 450 nm: −86.2 nm, out-of-plane retardation at 550 nm: −82.7 nm, out-of-plane retardation at 650 nm: −77.7 nm, thickness: 2 μm, MCP, DNP Co., Ltd.) was prepared.

The positive C retardation layer was attached to the reflective polarizer through a third adhesive layer and then attached to the negative dispersion retardation layer through the first adhesive layer, following by attaching the resulting stack to a pancake lens with a half mirror through a second adhesive layer, thereby obtaining an optical laminate of reflective polarizer-third adhesive layer-positive C retardation layer-first adhesive layer-negative dispersion retardation layer-second adhesive layer-pancake lens with half mirror. Each of the second adhesive layer and the third adhesive layer was an acrylic pressure sensitive adhesive layer.

Thereafter, a module for stereoscopic image display apparatuses was prepared in the same manner as in Example 1.

### Example 6

### Preparation of Optical Laminate

A first adhesive layer, a negative dispersion retardation layer, and a reflective polarizer were prepared in the same manner as in Example 1.

A positive C retardation layer (liquid crystal layer, thickness: 2 μm, MCP, DNP Co., Ltd.) was prepared.

The negative dispersion retardation layer was attached to the reflective polarizer through the first adhesive layer and then attached to the positive C retardation layer through a third adhesive layer, followed by attaching the resulting stack to a pancake lens with a half mirror through a second adhesive layer, thereby obtaining an optical laminate of reflective polarizer-first adhesive layer-negative dispersion retardation layer-third adhesive layer-positive C retardation layer-second adhesive layer-pancake lens with half mirror. Each of the second adhesive layer and the third adhesive layer was an acrylic pressure sensitive adhesive layer.

Thereafter, a module for stereoscopic image display apparatuses was prepared in the same manner as in Example 1.

### Comparative Example 1

A module for stereoscopic image display apparatuses was prepared in the same manner as in Example 1 except that the content of each component used in preparation of the first adhesive layer was changed to change the modulus of the first adhesive layer as shown in Table 1.

### Reference Example 1

### Preparation of Optical Laminate

A first adhesive layer was prepared in the same manner as in Example 1. The thickness and modulus of the first adhesive layer were as shown in Table 1.

A negative dispersion retardation layer (PC film, thickness: 50 μm, RM, Teijin Ltd.) was prepared.

A reflective polarizer and a pancake lens with a half mirror (identical to those in Example 1) were prepared.

The negative dispersion retardation layer was attached to the reflective polarizer through a first adhesive layer and then attached to a pancake lens with a half mirror through a second adhesive layer, thereby obtaining an optical laminate. The second adhesive layer was an acrylic pressure sensitive adhesive layer.

Thereafter, a module for stereoscopic image display apparatuses was prepared in the same manner as in Example 1.

Each of the modules for stereoscopic image display apparatuses prepared in Examples and Comparative Examples was evaluated as to the following properties. Results are shown in Table 1.

*Resolution (modulation transfer function (MTF)) (unit: %): Resolution was evaluated by measuring a contrast ratio, that is, a difference in brightness between light and dark areas on a screen, using an imaging photometer (ProMetric, Radiant Imaging Co.). A higher MTF value indicates better resolution.

$$MTF = \{ ( Maximum contrast ratio - Minimum contrast ratio ) / ( Maximum contrast ratio + Minimum contrast ratio ) \} \times 100$$

*Light leakage: Diagonal light leakage was observed with the naked eye in a darkroom. When no light leakage was observed with the naked eye, a corresponding module was rated as “undetectable” and, when light leakage was observed with the naked eye, a corresponding module was rated as “weak”, “medium”, or “strong” based on the observed intensity of light leakage.

*Presence of defects (such as lifting and bubbling) upon attachment using first adhesive layer: The presence of defects such as lifting and bubbling upon attachment using the first adhesive layer was checked with the naked eye.

TABLE 1

| | | | Degree of biaxiality of laminate* | | | | | |
|---|---|---|---|---|---|---|---|---|
| | First adhesive layer | | 450 | 550 | 650 | | Light | |
| | Modulus | Thickness | nm | nm | nm | Resolution | leakage | Defect |
| Example | 1 × 10⁶ | 15 | — | — | — | 85 | Undetectable | Undetectable |
| 1 | | | | | | | | |
| Example | 1 × 10⁶ | 18 | — | — | — | 86 | Undetectable | Undetectable |
| 2 | | | | | | | | |
| Example | 1 × 10⁷ | 15 | — | — | — | 85 | Undetectable | Undetectable |
| 3 | | | | | | | | |
| Example | 1 × 10⁶ | 10 | — | — | — | 87 | Undetectable | Undetectable |
| 4 | | | | | | | | |
| Example | 1 × 10⁶ | 15 | 0.73 | 0.61 | 0.56 | 91 | Undetectable | Undetectable |
| 5 | | | | | | | | |
| Example | 1 × 10⁶ | 18 | 0.57 | 0.45 | 0.43 | 92 | Undetectable | Undetectable |
| 6 | | | | | | | | |
| Comparative | 1 × 10³ | 15 | — | — | — | 68 | Detectable | Bubbling |
| Example | | | | | | | | |
| 1 | | | | | | | | |
| Reference | 1 × 10⁶ | 15 | — | — | — | 86 | Undetectable | Undetectable |
| Example | | | | | | | | |
| 1 | | | | | | | | |

*Laminate in Table 1: a laminate of the negative dispersion retardation layer and the positive C retardation layer.

As can be seen from Table 1, the optical laminates for stereoscopic image display apparatuses of Examples were each free from defects, such as lifting and/or bubbling, upon bonding to the pancake lens and could be reliably bonded to the pancake lens. In addition, the optical laminates of Examples could improve the contrast ratio and resolution of the stereoscopic image display apparatus while eliminating light leakage at an edge of a screen within a viewer's field of view.

Conversely, the optical laminate of Comparative Example 1, including a first adhesive layer having a modulus outside the range described herein, failed to improve resolution and eliminate light leakage and suffered bubbling upon bonding to the pancake lens. In addition, the optical laminate of Reference Example 1, including a thick negative dispersion retardation layer, did not suffer the problems that the present disclosure aims to solve.

As used herein, the terms “use,” “using,” and “used” may be considered synonymous with the terms “utilize,” “utilizing,” and “utilized,” respectively. As used herein, the term “one surface” and the “other surface”, unless stated otherwise, refer to two opposing surfaces of a member.

The use of “may” when describing embodiments of the inventive concept refers to “one or more embodiments of the inventive concept.”

Also, any numerical range recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein.

It should be understood that various modifications, changes, alterations, and equivalent embodiments can be made by those skilled in the art without departing from the spirit and scope of the disclosure. Accordingly, it is to be understood that present disclosure is not limited to the disclosed embodiments, but, on the contrary, is intended to cover various modifications and equivalent arrangements included within the spirit and scope of the appended claims, and equivalents thereof.

What is claimed is:

1. An optical laminate for stereoscopic image display apparatuses, comprising:
a negative dispersion retardation layer; and
a first adhesive layer and a reflective polarizer sequentially formed on a first surface of the negative dispersion retardation layer,
wherein the first adhesive layer has a storage modulus of 1×10⁶ Pa or more at 25° C.

2. The optical laminate as claimed in claim 1, wherein the negative dispersion retardation layer is 5 μm or less in thickness.

3. The optical laminate as claimed in claim 1, wherein the negative dispersion retardation layer comprises a liquid crystal layer.

4. The optical laminate as claimed in claim 1, wherein the negative dispersion retardation layer has a short-wavelength dispersion of 0.81 to 0.87 and a long-wavelength dispersion of 1.01 to 1.05.

5. The optical laminate as claimed in claim 1, wherein a slow axis of the negative dispersion retardation layer is tilted at an angle of 44° to 46° or 134° to 136° with respect to one side of the negative dispersion retardation layer.

6. The optical laminate as claimed in claim 1, wherein the first adhesive layer has a greater thickness than the negative dispersion retardation layer.

7. The optical laminate as claimed in claim 1, wherein the first adhesive layer comprises a pressure sensitive adhesive layer.

8. The optical laminate as claimed in claim 1, wherein the reflective polarizer is 30 μm or less in thickness.

9. The optical laminate as claimed in claim 1, further comprising:
a pancake lens formed on a second surface of the negative dispersion retardation layer.

10. The optical laminate as claimed in claim 1, further comprising:
a positive C retardation layer formed on at least one surface of the negative dispersion retardation layer.

11. The optical laminate as claimed in claim 10, wherein the positive C retardation layer has positive dispersion.

12. The optical laminate as claimed in claim 10, wherein a laminate of the negative dispersion retardation layer and the positive C retardation layer has a degree of biaxiality of 0.4 to 0.8 at a wavelength of 450 nm, a degree of biaxiality of 0.3 to 0.7 at a wavelength of 550 nm, and a degree of biaxiality of 0.3 to 0.7 at a wavelength of 650 nm.

13. The optical laminate as claimed in claim 10, wherein the positive C retardation layer is between the negative dispersion retardation layer and the reflective polarizer, on a second surface of the negative dispersion retardation layer, the second surface facing away from the reflective polarizer, or on both the first surface and the second surface of the negative dispersion retardation layer.

14. The optical laminate as claimed in claim 1, further comprising:
a linear polarizing plate arranged on an optical path of light transmitted through the reflective polarizer.

15. The optical laminate as claimed in claim 14, wherein the linear polarizing plate comprises a polarizer, and a light absorption axis of the polarizer of the linear polarizing plate is tilted an angle of 44° to 46° or 134° to 136° with respect to a slow axis of the negative dispersion retardation layer.

16. The optical laminate as claimed in claim 14, wherein the linear polarizing plate comprises a polarizer and a protective layer formed on at least one surface of the polarizer.

17. The optical laminate as claimed in claim 14, further comprising:
a lens arranged on at least one surface of the negative dispersion retardation layer.

18. A stereoscopic image display apparatus comprising the optical laminate as claimed in claim 1.

19. The stereoscopic image display apparatus as claimed in claim 18, comprising:
a display unit;
a first polarizing plate; and
a pancake lens assembly,
wherein the pancake lens assembly comprises the optical laminate.

20. The stereoscopic image display apparatus as claimed in claim 19, further comprising: a second polarizing plate between the first polarizing plate and the pancake lens assembly.
